(19) United States
(12) Patent Application Publication
(10) Pub. No.: US 2023/0193153 A1
(43) Pub. Date: Jun. 22, 2023

(54) PROCESS FOR MAKING OIL-FREE COMPOSITIONS COMPRISING PHOSPHOLIPDS

(71) Applicant: Cargill, Incorporated, Wayzata, MN (US)

(72) Inventors: Tobias BRUECHER, Hamburg (DE); Norman Philipp MATTHIESSEN, Hamburg (DE); Susanne TIROK, Hamburg (DE); Arnulf SCHOEPPE, Hamburg (DE); Daniel STEIGER, Pinneberg (DE)

(73) Assignee: Cargill, Incorporated, Wayzata, MN (US)

(21) Appl. No.: 18/000,211

(22) PCT Filed: May 25, 2021
(86) PCT No.: PCT/US2021/033968

§ 371 Date: Nov. 29, 2022

(30) Foreign Application Priority Data
May 30, 2020 (EP) 20177633.3

(51) Int. Cl. C11B 13/00; A23G 1/36; A23J 7/00; A23L 29/10; A23D 9/013; A23D 9/04

(52) U.S. Cl. CPC C11B 13/00; A23G 1/36; A23J 7/00; A23L 29/10; A23D 9/013; A23D 9/04

(57) ABSTRACT

The present invention relates to a method of for extracting oil from an oil-containing phospholipid composition, comprising the steps of: (a) Providing the oil-containing phospholipid composition, said composition comprising phospholipids and oil, the oil being in an amount of between and 80 wt % relative to the total weight of the oil composition; (b) Admixing water with the oil-containing phospholipid composition to obtain an aqueous composition, wherein the weight ratio of composition to water is between 6.0:1.0 and 1.3:1.0; (c) Separating the aqueous composition into an oil-rich fraction and an oil-depleted fraction, the oil-depleted fraction comprising water and phospholipids; and (d) removing the separated oil-rich fraction to obtain an aqueous, oil-depleted fraction comprising phospholipids; (e) optionally drying the aqueous, oil-depleted fraction to obtain a dried oil-depleted fraction comprising phospholipids.

### FIELD OF THE INVENTION

The present invention relates to a method for extracting oil from an oil composition comprising phospholipids. The invention further relates to an oil-free composition comprising phospholipids obtained by the method of the invention and its use in food, beverages, nutritional products, dietary supplements, feed, personal care applications, pharmaceutical applications and industrial applications.

### BACKGROUND OF THE INVENTION

Vegetable composition containing phospholipids are by-products of the production of oil. As natural emulsifying agents with excellent technological and nutritional-physiological properties, these composition are highly valued in various industries and in the food industry in particular. Today, already more than 800 million people consume products daily which contain phospholipids. More and more synthetic emulsifying agents and stabilizers are being replaced therewith.

The demand for naturally processed products, including those containing phospholipids, is also rising. In many food applications, a change is taking place towards the use of cleaner ingredients. In particular oil-free compositions containing phospholipids are highly desirable due to their high emulsifying capacity and excellent water dispersibility. Unfortunately, such oil-free compositions are typically produced using organic solvents, e.g. acetone, for certain products this being undesirable. There is therefore a need for cleaner oil-free compositions containing phospholipids.

“Degumming” is the name given to processes in which inter alia phospholipids are removed from a raw oil. A simple degumming process comprises merely admixing water with the oil and separating the resulting mixture into an oil component and an aqueous component containing inter alia some of the phospholipids. An example of such a process is given in CA-A-522398 in which a water degumming process for rice bran oil is described. Rice bran oil contains a high proportion of waxes and the process described in CA-A-522398 comprises heating the oil/water mixture to hydrate the gums and then slowly cooling the mixture to allow wax crystals to coalesce and so be separated with the aqueous component. Reheating of the separated aqueous or sludge component is said to permit extraction of the waxes as well as entrained oil.

Another attempt to remove phospholipids from a triglyceride oil is described in U.S. Pat. No. 4,162,260 in which it is proposed to remove impurities from a triglyceride oil by increasing the level of hydratable phosphatides prior to degumming.

A problem however exists in the known processes such as degumming processes, in that it is very difficult to extract a majority of the oil. Even when repeating the process a number of times, a large amount of oil still remains present in the composition containing the phospholipids. There is therefore a need for a process able to extract most of the oil content and provide essentially an oil-free phospholipid compositions.

### SUMMARY OF THE INVENTION

The present invention provides a method for extracting oil from an oil-containing phospholipid composition, comprising the steps of:
a) Providing the oil-containing phospholipid composition, said composition comprising phospholipids and oil, the oil being in an amount of between 20 and 80 wt % relative to the total weight of the oil composition;
b) Admixing water with the oil-containing phospholipid composition to obtain an aqueous composition, wherein the weight ratio of composition to water is between 6.0:1.0 and 1.3:1.0;
c) Separating the aqueous composition into an oil-rich fraction and an oil-depleted fraction, the oil-depleted fraction comprising water and phospholipids; and
d) removing the separated oil-rich fraction to obtain an aqueous, oil-depleted fraction comprising phospholipids;
e) optionally drying the aqueous, oil-depleted fraction to obtain a dried oil-depleted fraction comprising phospholipids.

The present inventors observed that the method according to the invention (hereinafter “the inventive method”) is able to produce an oil-depleted composition comprising phospholipids in an efficient and economical manner. In particular, the oil-depleted composition obtained by the method of the invention may contain some residual oil, in such small amounts which to inventors' knowledge have never been achieved hitherto.

Other advantages of the invention will become apparent from the detailed description given hereunder.

### DETAILED DESCRIPTION OF THE INVENTION

The invention relates to a method (hereinafter the inventive method) for extracting oil from a composition comprising phospholipids and oil.

The oil-containing phospholipid composition comprises phospholipids and oil, the oil being in an amount of between 20 and 80 wt % relative to the total weight of the oil composition. Preferably, the amount of oil contained by said composition is between 25 and 75 wt %, most preferably between 30 and 70 wt %.

The oil-containing phospholipid composition can be obtained from a raw oil by e.g. degumming of the raw oil. The raw oil may be obtained, for example, from plants, animals, algae and/or microorganisms by pressing or extraction methods, e.g. using organic solvents. Hot-pressing and cold-pressing methods are known for the recovery of raw oil. Extraction processes as well can be employed, such as hexane extraction, for example. However, diverse alternative provision variants are contemplated. The raw oil here need not necessarily have been obtained directly from living entities, but may also, as in the case of frying or industrial oil, have already been used for its intended purpose one or more times. In particular, the term “raw oil” as used herein embraces compositions of biological origin which can be obtained from plants, algae, animals and/or microorganisms and which have a water content of preferably at most 10 wt % relative to the weight of the oil and a fraction of alkanes and/or cyclic aromatics and/or mono/di/triglycerides (acylglycerides) of at least 75 wt %.

If the raw oil is obtained from algae, said algae oils are preferably chosen from the groups consisting of Neochloris oleoabundans oil, Scenedesmus dimorphus oil, Euglena gracilis oil, Phaeodactylum tricornutum oil, Pleurochrysis carterae oil, Prymnesium parvum oil, Tetraselmis chui oil, Tetraselmis suecica oil, Isochrysis galbana oil, Nannochloropsis salina oil, Botryococcus braunii oil, Dunaliella tertiolecta oil, Nannochloris oil, Spirulina oil, Chlorophyceae oil, Bacilliarophyta oil, or a mixture of the preceding oils.

Preferably, the raw oil is a vegetable oil. Preferably, the vegetable oil is chosen from the group of oils consisting of acai oil, acrocomia oil, almond oil, babassu oil, blackcurrant seed oil, borage seed oil, rapeseed, oil, cashew oil, castor oil, coconut oil, coriander oil, corn oil, cottonseed oil, crambe oil, linseed oil, grape seed oil, hazelnut oil, other nut oils, hemp seed oil, jatropha oil, jojoba oil, macadamia nut oil, mango kernel oil, lady's smock oil, mustard oil, neat's foot oil, olive oil, palm oil, palm kernel oil, palmolein oil, peanut oil, pecan oil, pine kernel oil, pistachio oil, poppy oil, rice germ oil, safflower oil, camellia oil, sesame oil, shea butter oil, soybean oil, sunflower oil, tall oil, tsubaki oil, walnut oil, grades of “natural” oils with fatty acid compositions that are modified by way of genetically modified organisms (GMOs) or traditional breeding, and a mixture of the preceding oils.

Most preferably the raw oil is a vegetable oil selected from the group consisting of sunflower oil, safflower oil, canola oil, rapeseed oil, rice bran oil, olive oil, soybean oil, corn oil, cotton oil, sesame seed oil, or palm olein, palm kernel olein, their corresponding high oleic varieties, and mixture of two or more thereof. The high oleic varieties are oils containing at least 40%, at least 50%, at least 60%, at least 70% and preferably at least 80% oleic acid in respect of the fatty acid profile. Particularly preferred liquid oil are sunflower oil, rapeseed oil, soybean oil, palm olein (mono- or bi-fractionated) and palm kernel oil.

The content of the oil-containing phospholipid composition used in accordance with the invention will depend on the raw oil used as the source from which said composition is obtained. For the purpose of the invention, the oil composition contains phospholipids and between 20 and 80 wt % of oil, the oil being the oil naturally present in the raw oil. The oil composition may also contain waxes, gums, glucosides and the like and water. Preferably, the oil composition contains an amount of water of at most 50 wt %, more preferably at most 35 wt %, most preferably at most 25 wt %, relative to the weight of said composition, provided that the amount of oil in said composition is within the required range. Preferably, said amount of water is at least 1 wt %, more preferably at least 3 wt %, most preferably at least 5 wt %.

The oil-containing phospholipid composition contains phospholipids. Depending on the raw oil, the nature and content of the phospholipids in the oil composition may vary. The phospholipids (also referred to as phosphatides) are phosphorus-containing organic substances which have the properties of a fat. The phospholipids are differentiated into non-hydratable phospholipids (NHP) and hydratable phospholipids (HP). Examples of hydratable or partially hydratable phospholipids include phosphatidylinositol or salts thereof, phosphatidylcholine and phosphatidylethanolamine. Examples of non-hydratable phospholipids are salts of phosphatidic acid (e.g. calcium or magnesium salts thereof). Examples of typical cations of the phospholipids are sodium, potassium, calcium, etc.

Preferably, the oil-containing phospholipid composition is obtained from the raw oil by a degumming operation of the raw oil. In this operation, water is typically added to the raw oil to cause the phospholipids to sediment and help their removal from the raw oil. Where the phospholipids are hydratable, they are hydrated by the addition of the water to the raw oil. The sedimented phospholipids can be separated centrifugally from the oil. Non-hydratable phospholipids can either be converted into a hydratable form, e.g. by the addition of an acid, and/or they can be removed by filtration or using solvents. In particular, the addition of acid may comprise the addition of a dilute acid or, likewise preferably, the addition of a concentrated acid in conjunction with a subsequent addition of water. The addition of acid is called acid degumming, whereas the addition of water is known as water degumming. Preferably, the acid degumming is carried out by dispersing in the raw oil an acid or an acid anhydride, having a pH of at least 0.5 as measured in a molar aqueous solution at 20° C., dispersing 0.2 to 5% water by weight of the raw oil in the mixture so obtained and maintaining the resulting mixture for at least 5 minutes at a temperature below 40° C. prior to separation into an oil fraction and a sludge fraction.

After degumming, (i) a degummed oil fraction is obtained which, however, still has a residual fraction of phospholipids, mainly non-hydratable phospholipids, and (ii) a sludge fraction is obtained enriched in phospholipids, mainly hydratable phospholipids, and containing oil and some water. The sludge fraction is used for the purpose of the invention and referred to herewith for simplicity as the oil-containing phospholipid composition. The degumming process can be easily and routinely carried out to provide the oil-containing phospholipid composition suitable for being used in the present invention.

Preferably, the oil-containing phospholipid composition contains phospholipids in an amount (as measured by the Acetone Insoluble (AI) method presented in the METHODS section) of at least 20 wt % relative to the weight of said composition, more preferably in an amount of at least 40 wt %, most preferably in an amount of at least 60 wt %, provided that the oil amount of said composition is within the required range. Said phospholipids amount is preferably at most 75 wt %, more preferably at most 73 wt %, most preferably at most 70 wt %. A skilled person can easily adjust the AI concentration by e.g. varying the parameters of the degumming process such as the water amount used to degum (using lower water amounts will lead to higher AI).

The inventive method further implies a step where water is admixed with the oil-containing phospholipid composition in a carefully chosen ratio. The present inventors observed that when the weight ratio of said composition to water is between 6.0:1.0 and 1.3:1.0, the oil extraction from said composition is facilitated. Preferably, the weight ratio of composition to water is between 6.0:1.0 and 1.5:1.0, more preferably between 5.5:1.0 and 1.5:1.0, more preferably between 5.0:1.0 and 1.5:1.0, more preferably between 4.0:1.0 and 2.0:1.0, most preferably between 3.5:1.0 and 2.5:1.0. Admixing the water with the oil-containing phospholipid composition can be carried out using conventional means in the art, e.g. mixers such as static mixers, dynamic mixers, high shear mixers and centrifugal pumps.

Preferably, the oil-containing phospholipid composition is heated to a temperature of at most 90° C., more preferably of at most 80° C., most preferably of at most 70° C. before admixing the water in step b. of the inventive method. Preferably, the temperature of said composition before admixing it with water is at least 30° C., more preferably at least 40° C., most preferably at least 50° C.

Preferably, the temperature of water, which is admixed with the oil-containing phospholipid composition in step b. of the inventive method, is at most 95° C., more preferably at most 85° C., most preferably at most 75° C. Preferably, the water temperature of the oil composition before the admixture of water is at least 30° C., more preferably at least 40° C., most preferably at least 50° C.

The water can be admixed with the oil-containing phospholipid composition using known means, e.g. static or dynamic mixers. Preferably the admixing is carried out under stirring with a speed of at most 10 000 rpm, preferably at most 5000 rpm, more preferably at most 1000 rpm. Preferably, the stirring speed is at least 100 rpm, more preferably at least 200 rpm, most preferably at least 300 rpm.

Preferably, the admixing is carried out under stirring with a speed of between 100 and 10000 rpm, the water has a temperature of between 30 and 95° C. and the oil-containing phospholipid composition has a temperature between 30 and 90° C. It is contemplated that during certain stirring conditions, e.g. high stirring speed, part of the stirring energy might be transformed into heat and consequently the temperature of the aqueous solution might increase. Preferably, the aqueous composition has a temperature of at most 90° C., more preferably at most 85° C., most preferably at most 80° C. Preferably, the aqueous composition has a temperature of at least 40° C., more preferably at least 50° C., most preferably at least 60° C.

The aqueous composition has preferably a pH of at least 5.0, more preferably at least 5.5, most preferably at least 6.0. Preferably, the pH of the aqueous composition is at most 8.5, more preferably at most 8.0, most preferably at most 7.5. Preferably, said pH is between 5.0 and 8.5, more preferably between 5.5 and 8.0, most preferably between 6.0 and 7.5. The pH of the aqueous composition can be adjusted by well-known means, e.g. by adding a base (or an alkali), preferably a food grade base or by using a pH buffer. A buffer solution (more precisely, pH buffer or hydrogen ion buffer) is an aqueous solution consisting of a mixture of a weak acid and its conjugate base, or vice versa. Its pH changes very little when a small amount of strong acid or base is added to it. Buffer solutions are used as a means of keeping pH at a nearly constant value in a wide variety of applications, e.g. food, personal care and pharma applications. Preferably, a food grade base is utilized to adjust the pH of the aqueous environment, non-limiting examples thereof including ammonium hydroxide or aqueous ammonia, sodium hydroxide, sodium bicarbonate, potassium hydroxide, potassium carbonate and calcium hydroxide, quicklime/calcium oxide, calcium carbonate, and mixtures thereof. The pH can be measured with any pH-meter known in the art after carrying out its calibration (if required) and using it as indicated in the operating instructions.

By aqueous composition is herein meant a liquid composition which contains water, non-limiting example thereof including pure water (e.g. reverse osmosis water), a water solution and a water suspension. Within the context of the present invention, preferred aqueous environments are purified water or tap water. Preferably, the aqueous composition contains at least 30 wt % water based on the total weight of said composition, more preferably at least 40 wt % water, even more preferably at least 50 wt % water, even more preferably at least 60 wt % water, even more preferably at least 70 wt % water, even more preferably at least 80 wt % water, most preferably at least 90 wt % water. The remaining wt % up to 100% may comprise additives; preservatives; vitamins; sterols like phytosterols; antioxidants like polyphenols; beneficial minerals for human nutrition; whole vegetable extracts; cellulose such as microfibrillated cellulose and cellulose gel; dextrin; maltodextrin; sugars like sucrose, glucose; polyols like mannitol, erythritol, glycerol, sorbitol, xylitol, maltitol; protein or protein hydrolysate like plants or vegetables proteins and dairy proteins; oils and fat; surfactants; lecithin; glucomannans and/or galactomannans, e.g. guar gum, xanthan gum, locust bean gum, cassia gum, tara gum, konjac gum, alginate, agar, gellan gum, carrageenan and beta 1,3 glucan; native starch; modified starch; and combinations thereof.

The aqueous composition is subsequently separated into an oil-rich fraction and an oil-depleted fraction. The oil-depleted fraction contains water, phospholipids and might contain also residual quantities of oil. The final composition of the oil-depleted fraction depends on the raw oil used in accordance with the invention and may contain inter alia minute quantities of waxes, gums, glucosides, and the like.

The inventors observed that the initial steps (i.e. the steps preceding the separation step) of the inventive method, facilitate the separation step, in that the amount of oil in the oil-depleted fraction is at most 10 wt % relative to the mass of said fraction, more preferably at most 9 wt %, most preferably at most 8 wt %. Preferably, the separation step is carried out at a temperature, i.e. the temperature of the aqueous composition, of at most 90° C., more preferably of at most 85° C., most preferably of at most 80° C. Preferably, the temperature of the aqueous composition is at least 5° C., more preferably at least 15° C., most preferably at least 30° C. Suitably the temperature of the aqueous composition is adjusted or maintained by passage through a heat exchanger for example a plate heat exchanger or a tube heat exchanger Or by use of microwave heating.

Preferably, the separation step is carried out for about 1 hour to about 120 hours so as to allow the oil-rich phase to separate efficiently from the oil-depleted fraction. Separation of the aqueous composition into the oil-rich phase and the oil-depleted fraction can thus be, and most preferably is, effected in the absence of an organic solvent.

Preferably the separation of the aqueous composition into the oil-rich phase and the oil-depleted fraction is carried out centrifugally. Alternatively settling may be employed.

In a centrifuge, there is centrifugal separation into two phases with different densities, these phases flowing off from the centrifuge through drains. The centrifuge used is preferably a separator with an axis of rotation (can be vertical or horizontal), designed to separate two liquid phases having different densities. Preferably, the separation is carried out centrifugally under a separation force of at least 1500 G, more preferably at least 3000 G, most preferably at least 5000 G. Preferably, the centrifugal separation is carried out for at least 5 minutes, more preferably for at least 15 minutes, most preferably for at least 30 minutes. Preferably, the aqueous composition during the centrifuging step has a temperature of at most 60° C., more preferably at most 55° C., most preferably at most 50° C. Preferably, said temperature is at least 5° C., more preferably at least 15° C., most preferably at least 25° C.

Preferably, the oil-depleted fraction is dried, e.g. freeze-dried or vacuum dried, to a moisture content of at most 5.0 wt %, more preferably at most 2.0 wt %, most preferably at most 1.0 wt %. Preferably, said moisture content is at least 0.1 wt %, more preferably at least 0.3 wt %, most preferably at least 0.5 wt %. The dried oil-depleted fraction can be milled into a powder as such a powdery oil-depleted fraction is easier to manipulate and more economically to transport.

It is contemplated that after carrying out the initial steps of the process (e.g. steps a. to d.) the oil-depleted fraction may still contain oil in an amount larger than desired (e.g. an amount of between 20 and 40 wt %). This may be the case when the oil-containing phospholipid composition used in the inventive method as the starting or input material contains a high amount of oil, e.g. above 30 wt %. In this case the inventive method can be applied on the oil-depleted fraction a number of times, e.g. at least one more time, more preferably at least two times, in order to lower further the amount of oil contained by the oil-depleted fraction, preferably to below 10 wt %, more preferably to at most 9 wt %, most preferably to at most 8 wt %.

Preferably, steps c)-d) are repeated at least one more time, i.e. the oil-depleted fraction obtained at step d) is processed again according to the inventive process, i.e. it is separated into the indicated fractions in step c) and the oil-rich fraction in step d) is removed. Preferably, steps c)-d) are repeated at least two times, most preferably at least three times.

The invention further relates to a water de-oiled phospholipid composition (hereinafter referred to for simplicity as the inventive composition) comprising water, phospholipids and oil, said composition having an AI of at least 85 wt %, preferably at least 87 wt %, more preferably at least 89 wt %, more preferably at least 90.0 wt %, more preferably at least 91.0 wt %, more preferably at least 92.0 wt %, most preferably at least 94.0 wt %, the wt % being expressed relative to the total weight of the composition.

Preferably, the inventive composition has an amount of oil of at most 10 wt %, an amount of water of at most 5 wt % and an AI of at least 85.0 wt. Preferably, the oil is in an amount of at most 9.0 wt %, more preferably at most 8.0 wt %, more preferably at most 7.0 wt %, more preferably at most 6.0 wt %, more preferably at most 5.0 wt %, more preferably at most 4.0 wt %, most preferably at most 3.0 wt %. Preferably, the oil is in an amount of at least 0.1 wt %, more preferably at least 0.5 wt %, most preferably at least 1.0 wt %. Preferably, the water is in an amount of 5.0 wt %, more preferably at most 4.0 wt %, more preferably at most 3.0 wt %, more preferably at most 2.0 wt %, most preferably at most 1.0 wt %. Preferably, the water is in an amount of at least 0.1 wt %, more preferably at least 0.3 wt %, most preferably at least 0.5 wt %. Preferably, the AI is at least 87 wt %, more preferably at least 89 wt %, more preferably at least 90.0 wt %, more preferably at least 91.0 wt %, more preferably at least 92.0 wt %, most preferably at least 94.0 wt %. Preferably, the AI is at least 87 wt %, more preferably at least 89 wt %, more preferably at least 90.0 wt %, more preferably at least 91.0 wt %, more preferably at least 92.0 wt %, most preferably at least 94.0 wt % and the amounts of oil and water combined are at most 10.0 wt %, more preferably at most 8.0 wt %, most preferably at most 6.0 wt %, relative to the total weight of the composition.

The inventive composition preferably has an AI of at least 89 wt %, with the amount of oil being at most 9.0 wt % and the amount of water being at most 2 wt %. Preferably, the oil is in an amount of at most 8.0 wt %, more preferably at most 7.0 wt %, more preferably at most 6.0 wt %, more preferably at most 5.0 wt %, more preferably at most 4.0 wt %, most preferably at most 3.0 wt %.

The inventive composition preferably has an AI of at least 90 wt %, with the amount of oil being at most 8.0 wt % and the amount of water being at most 2 wt %. Preferably, the oil is in an amount of at most 7.0 wt %, more preferably at most 6.0 wt %, more preferably at most 5.0 wt %, more preferably at most 4.0 wt %, most preferably at most 3.0 wt %.

The inventive composition preferably has an AI of at least 91 wt %, with the amount of oil being at most 7.0 wt % and the amount of water being at most 2 wt %. Preferably, the oil is in an amount of at most 6.0 wt %, more preferably at most 5.0 wt %, more preferably at most 4.0 wt %, most preferably at most 3.0 wt %.

The inventive composition preferably has an AI of at least 92 wt %, with the amount of oil being at most 6.0 wt % and the amount of water being at most 2 wt %. Preferably, the oil is in an amount of at most 5.0 wt %, more preferably at most 4.0 wt %, most preferably at most 3.0 wt %.

The inventive composition preferably has an AI of at least 93 wt %, with the amount of oil being at most 5.0 wt % and the amount of water being at most 2.0 wt %. Preferably, the oil is in an amount of at most 3.0 wt %.

Preferably, the inventive composition of the invention is obtained by a de-oiling method using water, i.e. is a water de-oiled phospholipid composition. Preferably, the inventive composition is obtained by the inventive method. A characteristic of the water de-oiled phospholipid composition is that it contains tocopherol, a compound typically not present or present in extremely low amounts when the de-oiling is carried out using organic solvents. Preferably, the de-oiled phospholipid composition contains an amount of at least 0.01 wt % tocopherol, more preferably at least 0.03 wt %, most preferably at least 0.05 wt %, relative to the total weight of the composition. Additionally, the water de-oiled phospholipid composition can also contain zeaxantine and/or luteine, which are carotenoids and known for their antioxidant properties. These carotenoids are preferably present in an amount of between 0.10 and 0.25 mg/100 g of water de-oiled phospholipid composition, while being practically absent in solvent de-oiled phospholipid compositions.

The invention further relates to a food or a feed product containing the inventive composition and a nutrient.

The inventive composition is highly suitable for use in the production of a large variety of food products. Examples of food products comprising or being manufactured by using the inventive composition, to which the invention also relates, include: luxury drinks, such as coffee, black tea, powdered green tea, cocoa, adzuki-bean soup, juice, soya-bean juice, etc.; milk component-containing drinks, such as raw milk, processed milk, lactic acid beverages, etc.; a variety of drinks including nutrition-enriched drinks, such as calcium-fortified drinks and the like and dietary fiber-containing drinks, etc.; dairy products, such as butter, cheese, yogurt, coffee whitener, whipping cream, custard cream, custard pudding, etc.; iced products such as ice cream, soft cream, lacto-ice, ice milk, sherbet, frozen yogurt, etc.; processed fat food products, such as mayonnaise, margarine, spread, shortening, etc.; soups; stews; seasonings such as sauce, TARE, (seasoning sauce), dressings, etc.; a variety of paste condiments represented by kneaded mustard; a variety of fillings typified by jam and flour paste; a variety or gel or paste-like food products including red bean-jam, jelly, and foods for swallowing impaired people; food products containing cereals as the main component, such as bread, noodles, pasta, pizza pie, corn flake, etc.; Japanese, US and European cakes, such as candy, cookie, biscuit, hot cake, chocolate, rice cake, etc.; kneaded marine products represented by a boiled fish cake, a fish cake, etc.; live-stock products represented by ham, sausage, hamburger steak, etc.; daily dishes such as cream croquette, paste for Chinese foods, gratin, dumpling, etc.; foods of delicate flavor, such as salted fish guts, a vegetable pickled in sake lee, etc.; liquid diets such as tube feeding liquid food, etc.; supplements; and pet foods. These food products are all encompassed within the present invention, regardless of any difference in their forms and processing operation at the time of preparation, as seen in retort foods, frozen foods, microwave foods, etc.

The invention also relates to a cocoa based composition, comprising the water de-oiled phospholipid composition of the invention and a cocoa mass, said phospholipid composition being in an amount of between 0.05 wt % and 5.0 wt %, preferably between 0.1 wt % and 1.0 wt % relative to the weight of the cocoa based composition. The cocoa based composition may also contain cocoa butter. The cocoa mass is typically obtained by grinding cocoa beans.

The invention also relates to a product comprising the inventive composition and a surfactant system. Preferably, the surfactant system is in an amount of 0.1 to 50 wt-%, more preferably from 5 to 30 wt-%, and even more preferably from 10 to 25 wt-% with respect to the weight of the product. In general, the surfactants may be chosen from the surfactants described in well-known textbooks like “Surface Active Agents” Vol. 1, by Schwartz & Perry, Interscience 1949, Vol. 2 by Schwartz, Perry & Berch, Interscience 1958, and/or the current edition of “McCutcheon's Emulsifiers and Detergents” published by Manufacturing Confectioners Company or in “Tenside-Taschenbuch”, H. Stache, 2^{nd} Edn., Carl Hauser Verlag, 1981; “Handbook of Industrial Surfactants” (4^{th} Edn.) by Michael Ash and Irene Ash; Synapse Information Resources, 2008. The type of surfactant selected may depend on the type of application for which the product is intended. The surfactant system may comprise one type of surfactant, or a mixture of two or more surfactants. Synthetic surfactants preferably form a major part of the surfactant system. Thus, the surfactant system preferably comprises one or more surfactants selected from one or more of anionic surfactants, cationic surfactants, non-ionic surfactants, amphoteric surfactants and zwitterionic surfactants. More preferably, the one or more detergent surfactants are anionic, nonionic, or a combination of anionic and nonionic surfactants. Mixtures of synthetic anionic and nonionic surfactants, or a wholly anionic mixed surfactant system or admixtures of anionic surfactants, nonionic surfactants and amphoteric or zwitterionic surfactants may all be used according to the choice of the formulator for the required cleaning duty and the required dose of the cleaning composition. Preferably, the surfactant system comprises one or more anionic surfactants. More preferably, the surfactant system comprises one or more anionic surfactants selected from the group consisting of lauryl ether sulfates and linear alkylbenzene sulphonates.

For certain applications the product comprising a surfactant system preferably also comprises from 1 to 8 wt-% of an inorganic salt, preferably selected from sulfates and carbonates, more preferably selected from MgSO₄ and Na₂SO₄ and even more preferably MgSO₄. Preferably the product comprising a surfactant system is a cleaning composition, more preferably a hand dish wash composition. The product may further comprise suspended particles and/or air bubbles.

The invention further relates to a cosmetic product comprising the inventive composition. By cosmetic product is herein for example understood a product utilized to enhance the appearance or odor of the human or animal body. In addition to the inventive composition, the cosmetic product may include any further cosmetic ingredient, e.g. any ingredient commonly used in the formulation of said cosmetic products. Example of cosmetic products include skin-care creams lotions, perfumes, lipsticks, fingernail and toe nail polish, facial makeups, hair colors and hair sprays, moisturizers, gels, deodorants, hand sanitizers, baby products, bath oils, bubble baths, butters and the like. The cosmetic products of the present invention may be in any form or shape, e.g. liquid or cream emulsions.

The invention further relates to a pharmaceutical product comprising the inventive composition and a drug or drug releasing agent. By drug is herein understood a substance intended for use in diagnosis, cure, mitigation, treatment or prevention of a disease. The drug may be from natural origin, e.g. animal, microbial or plant origin; chemical origin, i.e. derived from chemical synthesis; or combinations thereof.

Any feature of a particular embodiment of the present invention may be utilized in any other embodiment of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the examples and comparative experiments, or where otherwise explicitly indicated, all numbers in this description indicating amounts of material or conditions of reaction, physical properties of materials and/or use are to be understood as modified by the word “about”. Unless specified otherwise, numerical ranges expressed in the format “from x to y” are understood to include x and y. When for a specific feature multiple preferred ranges are described in the format “from x to y”, it is understood that all ranges combining the different endpoints are also contemplated. For the purpose of the invention ambient (or room) temperature is defined as a temperature of about 20 degrees Celsius.

### Methods of Measurement

RO water means reverse osmosis (RO) low conductivity water (milli-Q Ultrapure Millipore 18.2MΩ·cm)
Acetone insolubles (AI) were determined according to Lange R., Fiebig H. J. (1999): Separation of Phospholipids, Standard Methods of DGF, Fett/Lipid 101: 77-79. This method is based on the solubility of lecithin components such as triglycerides, fatty acids, sterols, and other acetone-soluble components, and the insolubility of the phospholipids and glycophospholipids in acetone under the test conditions. The latter are termed acetone insolubles (AI). AI may also be determined in accordance with AACC International Method 58-35.01—“Acetone-Insoluble Lecithin”, however the former method is preferred.
Moisture content (“MC”): The moisture content of a sample was determined by weighing the sample, placing the sample in a pre-dried vessel and subsequently heating the vessel containing the sample overnight in an oven at 105° C. The moisture content (in wt %) was calculated as MC=(A₁-A₂)/A₁×100 where A₁ was the weight of the sample before drying in the oven and A₂ was the weight of the resulted dried sample.
Dry substance content (“DS”) is measured according to formula: DS (%)=100% −MC (%).
Phospholipid Composition: The phospholipid composition, i.e. the amount of PC, PA, PI and PE and their hydrolysed fractions was determined using a liquid-chromatographic method applied on emulsifier compositions having an AI set to 60% relative to the total weight of the emulsifier composition. AI amount can be adjusted by adding (or extracting e.g. with acetone) the necessary amount of the acetone soluble part (mainly triglycerides) of said composition in order to bring the AI amount to 60%. The identification and quantification of the various phospholipid components may conveniently be executed by different methods, including thin-layer chromatography (TLC), high performance liquid chromatography (HPLC) and ³¹P nuclear magnetic resonance spectroscopy (³¹P-NMR) for the phospholipids only. Suitable methods are disclosed in London E., Feigenson G. W. (1979): Phosphorous NMR Analysis of Phospholipids in Detergents, J. Lipid Res. 20: 408-412; Aitzetmüller K. (1984): HPLC and Phospholipids, Part I: General Considerations, Fette, Seifen, Anstrichm. 86: 318-322; and Aloisi J. D., Sherma J., Fried B. (1990): Comparison of Mobile Phases for Separation and Quantification of Lipids by One-Dimensional TLC and Preadsorbent High Performance Silica Gel Plates, J. Liq. Chromatogr. 13:3949-3961.
Ionic strength (I) and pH adjustment: the supporting dispersing liquid was standardized tap water (1.00 g/L NaCl and 0.155 g/L CaCl₂·2H₂O) of ionic strength 0.02M prepared with reverse osmosis (RO) low conductivity water (milli-Q Ultrapure Millipore 18.2MΩ·cm). The pH was adjusted with 1M NaOH and the ionic strength adjusted by spiking the required mass of salt, NaCl or CaCl₂·2H₂O. The ionic strength I of the solution (in molar concentration M) was determined according to formula:

I=0.5([A]Z_{A}²+[B]Z_{B}²+[C]Z_{C}²+ . . . )

where [A], [B], [C] are the molar concentrations of ions A, B and C and Z_{A}, Z_{B}, Z_{C} are their respective charges. See Skoog, West & Holler (1996). Fundamentals of Analytical Chemistry, 7^{th} edition (Harcourt Brace & Company, Orlando). Practically, I=c (in M) for the [1:1] electrolytes (NaCl, NaOH), I=3c for the [2:1] electrolytes (CaCl₂).

The invention will now be described with the help of the following examples and comparative experiments, without being however limited thereto.

### EXAMPLE 1

225 gr of an oil-containing phospholipid composition obtained by degumming raw sunflower oil, having oil in an amount of 31 wt % and having an AI of 63.2 wt % was preheated to 55° C. and mixed with 75 g RO water having a temperature of 55° C. in ratio 3:1 to form an aqueous composition. The aqueous composition was than heated up to 70° C. in a thermostatic bath, homogenized by agitation (IKA stirring unit DW25, propeller stirrer 5 cm diameter) at 300 rpm and maintained under agitation and set temperature for 1 h. After 1 h, 4.53 g oil, which accumulated at the surface of the aqueous mixture was removed with a pipette.

The remaining aqueous composition was centrifuged (Centrifuge Sigma 3K-15 with rotor 11133) 2 times (a first time and a second time), each time for 1 h at 40° C. and 5500 rpm. In both cases, the separated oil-rich fraction was removed. The oil-depleted fraction comprising water, phospholipids and a residual amount of oil (about 17 g) was frozen at −20° C. overnight and subsequently, heated back to 40° C.

An amount of 0.7 g RO water was added to the unfrozen, heated samples, which were centrifuged again (third centrifugation) at 40° C. and 5500 rpms for 1 h. The obtained oil rich fraction was separated. In total 65 g of the oil was removed from the sample.

The oil-depleted fraction containing 75 g water was freeze-dried (Zirbus Technologies Vac05/Christ Alpha 2-4 with corresponding metal plates) to a moisture content of 1.1% and milled. The measured AI was 91.1%.

### EXAMPLE 2

EXAMPLE 1 was repeated with the difference that all centrifugation times were increased from 1 h to 2 h. The final AI after drying and milling was 92.4%.

### EXAMPLE 3

EXAMPLE 2 was repeated with the difference that the first centrifugation time was increased from 2 h to 2.5 h while the other 2 centrifugation steps were kept at 2 h. The final AI after drying and milling was 94.1%.

### EXAMPLE 4

Example 3 was repeated with a second batch of an oil containing phospholipid composition comprising sunflower oil (Oil 33%, AI 63.3%, Phospholipids 44.5%). The final AI after drying and milling was 91.7% and 94.1%.

### EXAMPLE 5

EXAMPLE 1 was repeated with the difference that complete centrifugation time was increased to 6.5 h (without any stop and no water was added during the centrifugation step) and the composition to water ratio was 1.5:1. The final AI after drying and milling was 93.3%.

### COMPARATIVE EXPERIMENTS

EXAMPLE 5 was repeated with the difference that various composition to water ratios were used (comparative experiment A and B). EXAMPLE 1 was repeated with the difference that various composition to water ratios were used (comparative experiment C and D). The details are presented in Table 1.

TABLE 1

| Comparative | | AI |
|---|---|---|
| Experiment | Ratio | (%) |
| A | 0.4:1 | 83.1 |
| B | 1:1 | 81.4 |
| C | 6.1:1 | 83.5 |
| D | 19:1 | 75.2 |

### EXAMPLE 6

An oil-containing phospholipid composition obtained by degumming raw sunflower oil, having oil in an amount of 36.5 wt % and having an AI of 63.5 wt % was preheated to 55° C. and mixed with RO water having a temperature of 55° C. to form an aqueous composition (see ratios in Table 2). The aqueous composition was than heated up to 70° C. in a thermostatic bath, homogenized by agitation (IKA stirring unit DW25, propeller stirrer 5 cm diameter) at 650 rpm and maintained under agitation and set temperature for 2 h. After that time, oil, which accumulated at the surface of the aqueous mixture was removed with a pipette. The remaining aqueous composition was centrifuged (Centrifuge Sigma 3K-15 with rotor 11133) for 1 h at 35 or 40° C. and 5500 rpm. The separated oil-rich fraction was removed. The oil-depleted fraction comprising water, phospholipids and a residual amount of oil was frozen at −40° C. overnight or directly freeze-dried.

The oil-depleted fraction containing water was freeze-dried (Zirbus Technologies Vac05 with corresponding metal plates) to a moisture content less than 1.5% and milled. The measured AI matters are presented in Table 2.

TABLE 2

| | | | | | oil rich | |
|---|---|---|---|---|---|---|
| trial | ratio | composition | water | centrifugation | fraction | AI |
| no. | [composition:water] | amount [g] | amount [g] | temperature [° C.] | removal [g] | [%] |
| 6.1 | 2.57:1 | 216.0 | 84.0 | 35 | 60.7 | 90.5 |
| 6.3 | 3:1 | 225.0 | 75.0 | 40 | 61.7 | 89.4 |

### EXAMPLE 7

An oil-containing phospholipid composition obtained by degumming raw sunflower oil, having oil in an amount of 36.2 wt % and having an AI of 63.8 wt % was preheated to 55° C. and mixed with RO water having a temperature of 55° C. to form an aqueous composition (see ratios in Table 3). The aqueous composition was then heated up to 70° C. in a thermostatic bath, homogenized by agitation (IKA stirring unit DW25, propeller stirrer 5 cm diameter) at about 300 rpm and maintained under agitation and set temperature for 1 h.

The aqueous composition was centrifuged (Centrifuge Sigma 3K-15 with rotor 11133) for 6.5 h at 40° C. and 5500 rpm (see Table 3). The separated oil-rich fraction was removed with a pipette directly or with the help of a spatula or spoon after samples were frozen to −20° C. over night. The oil-depleted fraction comprising water, phospholipids and a residual amount of oil was frozen at −40° C. or at −20° C. overnight or directly freeze-dried.

The oil-depleted fraction containing water was freeze-dried (Zirbus Technologies Vac05/Christ Epsilon 2-4 LSCplus with corresponding metal plates or in containers) to a moisture content less than 1.5% and milled. The AI are presented in Table 3.

TABLE 3

| | | composition | water | oil rich | |
|---|---|---|---|---|---|
| trial | ratio | amount | amount | fraction | AI |
| no. | [composition:water] | [g] | [g] | removal [g] | [%] |
| C.E. | 1:1 | 150.0 | 150.0 | 30.6 | 81.4 |
| 7.1 | 1.5:1 | 180.0 | 120.0 | 51.3 | 93.3 |
| 7.4 | 2:1 | 200.0 | 100.0 | 59.2 | 93.0 |

### EXAMPLE 9

The oil depleted fractions of EXAMPLE 4 were used in a chocolate recipe as follows: a dark chocolate sample was melted for 24 h before said fractions were added in amounts of between 0.1 to 0.7 wt % at 45° C. and blended in for 15 minutes using an IKA stirrer operating at 350 rpm. After mixing, the mixture was transferred to pots and allowed to crystallize.

Yield stress measurements were performed on the chocolate samples as follows: the samples were melted for 24 h at 45° C. and subsequently stirred with an IKA stirrer for 90 sec. at 300 rpm. The measurements were performed with an Anton Paar Rheometer (MCR 51) following IOCC2000 method. The yield stress values were calculated using the Casson method. All measurements were done in duplicate.

Comparative experiments were performed as described above, however instead of said fractions a commercial acetone-deoiled lecithin was used (EmulPur® from Cargill).

The experiments demonstrated that the yield stress values of the samples with the inventive water de-oiled composition were almost similar with those achieved using the commercial lecithin.

1. A method for extracting oil from an oil-containing phospholipid composition, the method comprising the steps of:
(a) providing the oil-containing phospholipid composition, said oil-containing phospholipid composition comprising phospholipids and oil, the oil being in an amount of between 20 and 80 wt % relative to the total weight of the oil-containing phospholipid composition;
(b) admixing water with the oil-containing phospholipid composition to obtain an aqueous composition, wherein the weight ratio of the oil-containing phospholipid composition to water is between 6.0:1.0 and 1.3:1.0;
(c) separating the aqueous composition into an oil-rich fraction and an oil-depleted fraction, the oil-depleted fraction comprising water and phospholipids;
(d) removing the separated oil-rich fraction to obtain an aqueous, oil-depleted fraction comprising phospholipids; and
(e) optionally drying the aqueous, oil-depleted fraction to obtain a dried oil-depleted fraction comprising phospholipids.

2. The method of claim 1, wherein the amount of oil contained by the oil-containing phospholipid composition is between 40 and 78 wt %.

3. The method of claim 1, wherein the oil-containing phospholipid composition is obtained by degumming a raw oil.

4. The method of claim 1, wherein the raw oil is a vegetable oil and the vegetable oil is selected from the group consisting of acai oil, acrocomia oil, almond oil, babassu oil, blackcurrant seed oil, borage seed oil, rapeseed oil, cashew oil, castor oil, coconut oil, coriander oil, corn oil, cottonseed oil, crambe oil, linseed oil, grape seed oil, hazelnut oil, other nut oils, hemp seed oil, jatropha oil, jojoba oil, macadamia nut oil, mango kernel oil, lady's smock oil, mustard oil, neat's foot oil, olive oil, palm oil, palm kernel oil, palmolein oil, peanut oil, pecan oil, pine kernel oil, pistachio oil, poppy oil, rice germ oil, safflower oil, camellia oil, sesame oil, shea butter oil, soybean oil, sunflower oil, tall oil, tsubaki oil, walnut oil, grades of “natural” oils with fatty acid compositions that are modified by way of genetically modified organisms (GMOs) or traditional breeding, and mixtures thereof.

5. The method of claim 1, wherein the oil-containing phospholipid composition contains phospholipids in an amount (as measured by the Acetone Insoluble (AI) method presented in the METHODS section) of at least 20 wt % relative to the weight of said composition.

6. The method of claim 1, wherein the weight ratio of the oil-containing phospholipid composition to water is between 5.0:1.0 and 1.5:1.0.

7. The method of claim 1, wherein the oil-containing phospholipid composition is heated to a temperature of at most 90° C. before admixing the water in step (b).

8. The method of claim 1, wherein the temperature of water, which is admixed with the oil-containing phospholipid composition in step (b), is at most 95° C..

9. The method of claim 1, wherein the separation step is carried out for 1 hour to 120 hours.

10. The method of claim 1, wherein the separation of the aqueous composition into the oil-rich phase and the oil-depleted fraction is carried out centrifugally.

11. The method of claim 1, wherein the oil-depleted fraction is dried to a moisture content of at most 5.0 wt %.

12. The method of claim 1, wherein steps c)-d) are repeated at least one more time.

13. A de-oiled phospholipid composition obtained by a de-oiling method using water, the de-oiled phospholipid comprising water, phospholipids and oil;
wherein:
the oil is in an amount of at most 10 wt %,
the water is in an amount of at most 5 wt % and having an AI of at least 85.0 wt %, and
the wt % being expressed relative to the total weight of the composition.

14. The composition of claim 13, containing an amount of at least 0.01 wt % tocopherol relative to the total weight of the composition.

15. A food product comprising the composition of claim 13 and a nutrient.
